(19) United States
(12) Patent Application Publication
(10) Pub. No.: US 2020/0024842 A1
(43) Pub. Date: Jan. 23, 2020

(54) THREE-DIMENSIONAL STRUCTURE PRINTER

(71) Applicant: 8D Technologies, Latrobe, PA (US)

(72) Inventor: Matthew Stephen Criado, Latrobe, PA (US)

(21) Appl. No.: 16/040,840

(22) Filed: Jul. 20, 2018

(51) Int. Cl. E04B 1/35; B33Y 10/00; B33Y 30/00; B33Y 50/02; E04B 1/16

(52) U.S. Cl. CPC E04B 1/3505; B33Y 10/00; E04B 1/16; B33Y 50/02; B33Y 30/00

(57) ABSTRACT

An embodiment provides a method for printing a three-dimensional structure, including: identifying, using one or more sensors, a geographical three-dimensional location of a print head, wherein the print head is operatively coupled to a platform providing movement over a geographical terrain; correlating the identified geographical location to a location identified within a print file, wherein the print file comprises dimensions and printed structure locations of a three-dimensional structure to be constructed; and constructing the three-dimensional structure until the three-dimensional structure is constructed by iteratively: moving, based upon the correlation, the print head to printed structure locations identified from the print file; when the print head is located at a printed structure location, extruding a structure material from a structure material holding location operatively coupled to the platform; and determining, based upon the print file, whether the three-dimensional structure is constructed.

### BACKGROUND

Three-dimensional (3D) printing allows for the printing of three-dimensional objects, for example, balls, trinkets, toys, and many other objects. Generally, 3D printers work by printing layers of material on top of other layers of material, thereby creating the three-dimensional object. Many 3D printers print using a plastic type material where the layers bond to each other, for example, using heat. To create the 3D object, the object's model is first provided to a system that works in conjunction with the 3D printer. For example, a 3D model may be generated of the object using modeling software. This file is then uploaded or otherwise provided to the 3D printing system. The 3D printing system then uses the 3D model, or other illustration which identifies the dimensions of the object to be printed, to print material at the locations identified in the print file. As the printer adds material at the locations indicated in the print file, the 3D object is created.

### BRIEF SUMMARY

One embodiment provides a method for printing a three-dimensional structure, comprising: identifying, using one or more sensors, a geographical three-dimensional location of a print head, wherein the print head is operatively coupled to a platform providing movement over a geographical terrain; correlating the identified geographical location to a location identified within a print file, wherein the print file comprises dimensions and printed structure locations of a three-dimensional structure to be constructed; and constructing the three-dimensional structure until the three-dimensional structure is constructed by iteratively: moving, based upon the correlation, the print head to printed structure locations identified from the print file; when the print head is located at a printed structure location, extruding a structure material from a structure material holding location operatively coupled to the platform; and determining, based upon the print file, whether the three-dimensional structure is constructed.

Another embodiment provides a system for printing a three-dimensional structure, comprising: a platform providing movement over a geographical terrain; a print head coupled to the platform; a structure material holding location operatively coupled to the platform; one or more sensors operatively coupled to the platform; a processor operatively coupled to the one or more sensors; a memory device operatively coupled to the processor, wherein the memory device stores instructions executable by the processor to: identify, using the one or more sensors, a geographical three-dimensional location of the print head, wherein the print head is operatively coupled to the platform; correlate the identified geographical location to a location identified within a print file, wherein the print file comprises dimensions and printed structure locations of a three-dimensional structure to be constructed; and construct the three-dimensional structure until the three-dimensional structure is constructed by iteratively: moving, based upon the correlation, the print head to printed structure locations identified from the print file; when the print head is located at a printed structure location, extruding a structure material from the structure material holding location; and determining, based upon the print file, whether the three-dimensional structure is constructed.

Another embodiment provides a product for printing a three-dimensional structure, comprising: a storage device that stores code, the code being executable by a processor and comprising: code that identifies, using one or more sensors, a geographical three-dimensional location of a print head, wherein the print head is operatively coupled to a platform providing movement over a geographical terrain; code that correlates the identified geographical location to a location identified within a print file, wherein the print file comprises dimensions and printed structure locations of a three-dimensional structure to be constructed; and code that constructs the three-dimensional structure until the three-dimensional structure is constructed by iteratively: moving, based upon the correlation, the print head to printed structure locations identified from the print file; when the print head is located at a printed structure location, extruding a structure material from a structure material holding location operatively coupled to the platform; and determining, based upon the print file, whether the three-dimensional structure is constructed.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example method of printing a three-dimensional structure.

FIG. 2 illustrates an example of a three-dimensional structure printer.

FIG. 3 illustrates an example of a three-dimensional structure printer print head.

FIG. 4 illustrates an example of computer circuitry.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Generally 3D printers are on stationary platforms. The printing heads, the mechanism that adds material to the desired locations, move around the platform and add material in the desired locations. Sensors on the printing heads communicate with the system in order to convey the location of the printing heads to the system. The system can then correlate the location of the printing head with the desired locations of material as identified in the print file. The system can thereby direct the printing heads to add material at the locations necessary for creating the 3D object. However, these stationary platforms limit the size of the object that can be created using the 3D printing process. Specifically, the 3D object has to be of a size that can fit on the 3D printing platform. Some 3D printers exist that are able to print large objects, for example, structures. However, like the smaller 3D printers, these printers are stationed on a stationary platform and require trailers or other movable platforms to move them from one location to another. Therefore, the printed structure can only be as large as the reach of the print head movement mechanism. In other words, the size of these structures is limited to a diameter or dimension that is smaller than where the printer can reach to add material.

3D printers use a printing material to create the 3D object. For example, most 3D printers use a plastic or plastic-type material for the 3D printing. However, some 3D printers can use other materials, for example, metal, ceramic, and the like. Some of the larger 3D printers, for example, the 3D printers that can print structures, use concrete. These 3D printers extrude the concrete through the printing heads at a specific consistency so that the concrete will maintain the desired structure. However, these structure printers are unable to use other printing materials due to the fact that the printed layers must adhere together and the material must maintain a specific consistency in order to maintain the structure. Additionally, the structures cannot be too large because the 3D printing process does not allow for addition of traditional structure supporting materials, for example, rebar or other structure material, that would add to the rigidity of the structure.

Accordingly, an embodiment provides a method for printing a three-dimensional structure using a platform that can move across multiple terrain types and a print head that can use different types of structure material to print the three-dimensional structure. The system includes a movable platform that can provide movement over a geographical terrain and a printing head coupled to the movable platform. The system identifies the geographical three-dimensional location of the print head using one or more sensors. The sensors may be located on the print head, a location near the print head, on the movable platform, at a location near the platform, a combination thereof, or the like. The three-dimensional geographical location is then relayed to a portion of the system that can correlate the location to a desired location, for example, a location identified from a print file associated with a structure to be constructed.

Based upon knowing the 3D location of the printing head and the desired location for printing the structure, the system can construct the three-dimensional structure. In constructing the three-dimensional structure the system can iteratively move the print head to locations identified from the print file. As the print head moves from one location to another, the print head extrudes a structure material at the locations identified from the print file. In other words, the system directs the print head which extrudes structure material at the necessary locations in order to print or construct the three-dimensional structure corresponding to the print file. If the system identifies a location where the print head cannot reach, for example, the structure is larger than the reach of mechanism holding the print head, the system provides instructions for movement of the mobile platform that positions the print head in a position to print the location. Once the system has determined that the structure is constructed, the system may stop the movement of the print head and/or platform.

The illustrated example embodiments will be best understood by reference to the figures. The following description is intended only by way of example, and simply illustrates certain example embodiments.

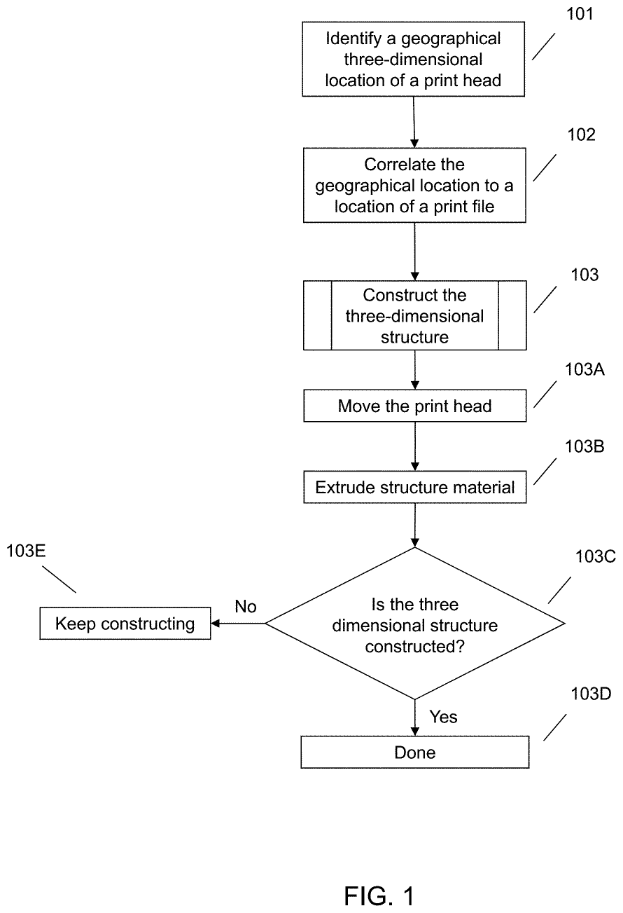

FIG. 1 illustrates a method for printing a three-dimensional structure using a platform the can move across multiple terrain types and a print head that can use different types of structure material to print the three-dimensional structure. At 101 the system may identify, using one or more sensors, a geographical three-dimensional location of a print head operatively coupled to a platform that provides movement over a geographical terrain. For example, the printing platform system (e.g., the portion of the 3D printing system that holds the printing head and any other components) may be construction equipment. As a non-limiting example, the printing platform system may be similar to an excavator. The excavator example will be used here throughout. However, it should be understood that other printing platform systems may be used, for example, other equipment retrofitted with the printing components, a platform specifically designed as the printing platform, vehicles fitted with the printing components, or the like. The moveable printing platform allows for traversing different terrains, for example, any terrain that an excavator would be able to traverse. Such a platform allows for printing of a 3D structure even in terrain that is difficult to get to or that would be difficult for traditional structure construction equipment (e.g., transport trucks, concrete trucks, supply trucks, etc.).

In the example of an excavator, the excavator includes a portion at the end of a boom that holds a desired mechanism or implement. For example, in construction projects, the implement may include a bucket, jackhammer, hook, ripper, or the like. In the case of the 3D printer described herein, the implement would be replaced by a print head. The installation of the print head can be accomplished using the mounting mechanisms already included on the excavator, for example, the pins and other holding mechanisms that hold the implement. In the case that the print head has a coupling mechanism different than the standard coupling mechanism of the excavator, the print head may include a coupler, adapter, or other mechanism that allows quick installation of the print head to the excavator.

Additionally, since the print head is installed without requiring special mounting mechanisms on the machine itself, the print head (and any other components of the printing system) can be uninstalled from the platform so that the platform can be used for other purposes, for example, the intended use of the platform as an excavator, thereby maintaining the versatility of the original machine while adding new versatility with the ability to install the printing system components at any time. In other words, the installation of the printing system components does not affect the base machine or platform in a manner that would cause the machine or platform to become inoperable for other or originally intended tasks.

Once the print head is connected to the machine, an operator can connect or couple the other components that are necessary for operation of the print head. This may include hydraulic hoses and control wires, which may already be included on the excavator. The hydraulic hoses and control wires are used to position the print head in three-dimensional space, in a manner similar to how the hydraulic hoses and control wires would be used to position a bucket, jackhammer, or other implement, installed at the end of the boom of the excavator. The printing system may also include a structure material hose that allows for conveyance of the structure material (e.g., concrete, wood fiber infused clay, plastic, etc.) from a structure material holding location to the print head. Other connections may be required, for example, the connection of a supporting structure member feeder that feeds a support structure member (e.g., rebar, wire, plastic, etc.) through or in addition to the print head.

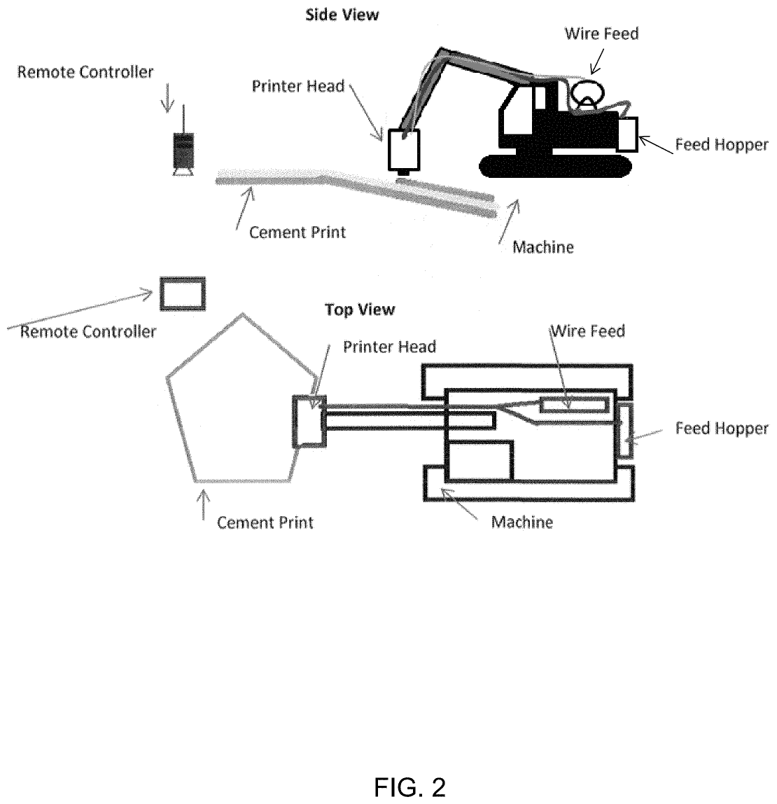

The printing platform may also include the supporting structure feeder and/or the structure material holding location. The supporting structure feeder is a component that holds the supporting structure material and allows for feed of the supporting structure material. For example, the supporting structure material may include rebar, wire, thick plastic, or the like, the can be fed into the structure to help hold the structure, much like traditional buildings. The supporting structure feeder may be a reel or other type of mechanism where the supporting structure material is held in a manner that allows for unrolling or pulling of the supporting structure material so that it can be installed during printing of the structure. For example, FIG. 2 illustrates a wire feed holding location.

The structure material holding location may include a tank or hopper that holds the structure material on the platform. For example, referring to FIG. 2, the excavator includes a feed hopper that holds the structure material. The structure material is then fed to the print head through a hose or other conveyance mechanism. Having the structure material holding location on the platform allows for movement of the 3D printer over all terrains without requiring the ability to have supporting vehicles follow the 3D printer. Alternatively, the structure material holding location may be separate from the platform. The structure material may then be fed to platform or print head through a hose or other conveyance mechanism from the structure holding location. The platform may also include connections for both an onboard structure material holding location and an off-board structure material holding location. The ability to use either an onboard or off-board material holding location allows the machine versatility to use whichever structure material holding location that is best suited for the desired job.

The printing system may also include other components. For example, as discussed briefly above, the printing system may include one or more sensors to determine the three-dimensional geographical location of the print head. The three-dimensional geographical location may include not only the location of the print head in an X and Y direction with respect to the ground or terrain, but may also indicate the distance of the print head from the ground or other surface under the print head (e.g., previously printed structure material layer), thus giving the three-dimensional location. In order to determine the three-dimensional geographical location of the print head, the print head itself may include one or more sensors that can be used to determine a position (e.g., position sensors, accelerometers, gyroscopes, inertial sensors, tilt sensors, global positioning sensors, etc.) that can communicate with a remote controller regarding the position of the print head in the three-dimensional geographical space. Additionally, other sensors may be included in the system, for example, the platform may include one or more sensors that can be used to determine the position of the platform.

The system may also include no sensors on the printing platform system. Rather, the system may include a controller or other device that can use different mechanisms to track the location of the print head and/or platform. For example, the system may include a remote controller that can use LiDAR, radar, laser, or other forms of computer vision, to detect the location of the printer and/or other components of the printing platform system. These systems may use different position technology and algorithms to detect the location of the printer. For example, the system may use algorithms such a time-of-flight, time-of-arrival, distance tracking, and the like, to detect how far the printer is from the sensor. These algorithms may rely on transmission of a signal and determination of how long it takes to receive the signal either at the transmission point or at a different point to determine how far the print head is from the transmission point. The system can then make calculations and then determine the three-dimensional geographical location of the print head. Alternatively, a combination of sensors either on or off the printing platform system may be used to determine the position of the print head.

Once the location of the print head is determined, the system may, at 102, correlate the identified geographical location of the print head to a location identified within a print file that includes dimensions and printed structure locations of a desired structure. In other words, the system identifies where the print head should be based upon the locations and dimensions included in the print file, and then identifies if the print head is at one of those locations. In correlating the locations, the system may also identify a best method for printing the three-dimensional structure. In other words, the system may optimize the printing of the structure. This optimization may take into account a particular terrain and the best way to traverse the terrain, a quickest way to perform the printing, parts of the structure that are required before other parts of the structure, a method of printing requiring the least number of platform movements, a method of printing requiring the least structure material, and the like. The optimization may be user configurable where the user identifies a priority of optimization. For example, a user may choose for the least number of platform movements to be a higher priority than use of the least amount of structure material.

At 103 the system may construct the three-dimensional structure. Construction of the three-dimensional structure may include iteratively moving the print head to a printing location as identified from the print file at 103A, extruding structure material while at a location identified as requiring structure material at 103B, determining whether the structure is complete or constructed at 103C, and either continuing constructing the structure at 103E if the structure is not complete or stopping construction at 103D if the structure is complete. In constructing the structure the system may continually correlate the location of the print head with locations in the print file to ensure that structure material is being placed in accordance with the print file. While the print head is at locations where structure material is identified as needed, the print head extrudes structure material through the print head.

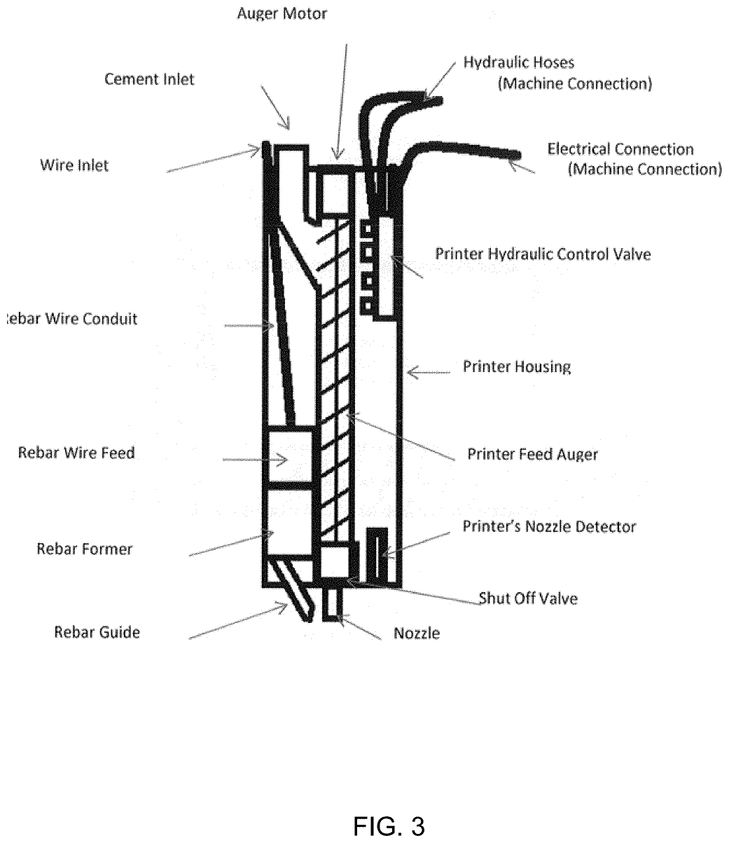

An example print head is shown in FIG. 3. The print head of FIG. 3 illustrates a potential configuration of the print head in the case that concrete is the structure material. In this configuration the print head includes an auger motor and auger that provides movement of the concrete to the print head nozzle. The hydraulic hoses and electrical connections are connected to the machine and control the location of the print head. The print head also includes a printer's nozzle detector that identifies the location of the nozzle, identifies a consistency of the material being extruded through the print nozzle, and/or identifies issues with the printing. In other words, the printer head may include one or more sensors that can “watch” (e.g., optical sensors, camera, humidity sensors, temperature sensors, consistency sensors, etc.) the extrusion process in order to ensure that the printing process is progressing as desired. This information can be fed back to the controller so that the controller can adjust the rate of printing, a ratio of structure material components (e.g., concrete, water, plastic, heat, clay, wood, etc.), an amount of supporting structure material, and the like. The print head also includes a shut off valve that can be used to shut off the ability of the print head to extrude material. The print head illustrated in FIG. 3 also includes components for feeding a supporting structure material, in this example, rebar, through the print head.

The structure material may include different types of material that can be used to construct a three-dimensional structure. The example illustrated in the figures is concrete. The concrete will be extruded through the print head to construct the three-dimensional structure (e.g., house, building, culvert, tunnel, etc.). In the case that concrete is used, the printing system may include components that support the use of concrete, for example, a concrete feeder that continually augers the concrete if necessary, water to change the consistency of the concrete, and the like. However, concrete is not the only structure material that is contemplated and other structure materials are possible. For example, another structure material that may be used is wood fiber infused clay. In this case the printer system may include components that support this structure material. For example, the system may include a wood shredder that can reduce the size of the wood to a size that can be mixed with the clay. The system may also include an auger that mixes the wood and clay. The system may also include water to change the consistency of the wood fiber infused clay.

Another structure material that may be used is plastic. The plastic may be created from trash or other materials. In this case the system may include a heater or other heating device that can heat the plastic to melt it so that it can be mixed and thereafter be extruded through the print head. The system may also include a grinder or other cutting mechanism that can reduce the size of the plastic to a size that reduces the amount of heat that is needed to melt the plastic. The print head may also include a heater that would be used to heat the plastic so that it can be extruded and so that it can adhere to other layers of the structure. Other structure materials may be used and are contemplated.

As with traditional 3D printers, the system may construct the structure in layers of material. Thus, the constructing of the structure may be performed by creating layers of material that are layered on top of each other to construct the entire structure. To ensure that the layers will adhere to each other, the print head may include one or more mechanisms that provide adherence. For example, in the case that the printer is using a structure material such as concrete, wood fiber infused clay, or other material that adheres with water, the print head may include a water nozzle that may spray or provide water between the layers as the print head is printing a layer on top of another layer. As another example, in the case that the printer is using a structure material such as plastic or other material that adhere with heat, the print head may include a heating element that heats the material as the printer is printing a layer on top of another layer.

As mentioned above, the print head may include a mechanism for installation of a supporting structure material, for example, rebar, wire, plastic, wood, and the like. The supporting structure material may be installed while the print head is extruding the structure material. The supporting structure material may be installed such that it traverses multiple layers of the printed structure. For example, the supporting structure material may be installed in a sinusoidal-type pattern where the supporting structure material starts in one layer moves downward through one or more other layers, then moves upward through the one or more layers to the starting layer, and so on. While the supporting structure material is being installed during printing, the system may include a component that can relay information back to the printer controller that informs the printer controller of the location of the supporting structure material so that structure printing can continue without being affected by the supporting structure material. This supporting structure material provides more rigidity to the structure. Additionally, the supporting structure material is able to be installed while the structure is being printed, unlike traditional printers where this is not possible.

In the case that the printing platform system has to be moved (e.g., the platform itself is moved from one location to another) the system may print layers on the edge of the print location in a stair-step pattern so that once the platform has moved, the next portion of the structure will adhere to the previous portion of the structure. In other words, if the structure is too large to be printed while the platform is in a single stationary location, or for some other reason that would require movement of the platform, the system may provide a means for connecting the first portion to another portion without degrading the structural integrity of the structure by printing a straight vertical surface between the two portions and will instead print a stair-step pattern for integration of one portion to another portion, for example, similar to how bricks are laid for a structure.

Moving the print head may include moving the boom to which the print head is attached, moving the print head itself, and/or moving the printing system platform. Movement of either or both the print head and the platform may be by way of an operator or electronics that control the print head and/or platform. In the case that electronics are used, the printing system platform may communicate with a remote controller that directs the movements of both the print head and the platform. For example, the system may use a “fly-by-wire” mechanism or a hydraulic pilot control system operated by electronic solenoids that control the machine, print head, platform, and/or other components of the printing platform system. As stated before, the movements may be optimized by the system in order to reduce the number of movements that are required to construct the structure.

Thus, the described systems and methods provide a system that allows for construction of a structure in locations that may not be possible to access using traditional equipment via use of an all-terrain platform. Additionally, the systems and methods as described herein provide a system that can used different types of support materials to construct the structure, where the platform includes the components necessary for construction using the structure materials. Finally, the described systems and methods provide for a system that can install supporting structure material during the construction of the structure without requiring manual installation of the supporting structure material and without degrading the printing process or performance.

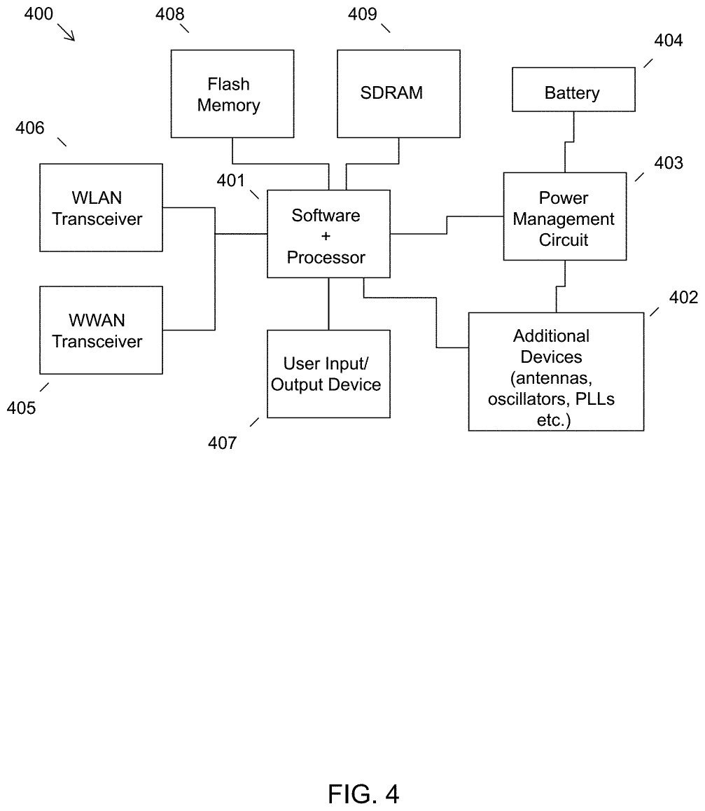

While various other circuits, circuitry or components may be utilized in information handling devices, with regard to an instrument for measuring fluid level and velocity according to any one of the various embodiments described herein, an example is illustrated in FIG. 4. Device circuitry 400 may include a measurement system on a chip design found, for example, a particular computing platform (e.g., mobile computing, desktop computing, etc.) Software and processor(s) are combined in a single chip 401. Processors comprise internal arithmetic units, registers, cache memory, busses, I/O ports, etc., as is well known in the art. Internal busses and the like depend on different vendors, but essentially all the peripheral devices (402) may attach to a single chip 401. The circuitry 400 combines the processor, memory control, and I/O controller hub all into a single chip 410. Common interfaces may include SPI, I2C and SDIO.

There are power management chip(s) 403, e.g., a battery management unit, BMU, which manage power as supplied, for example, via a rechargeable battery 404, which may be recharged by a connection to a power source (not shown). In at least one design, a single chip, such as 401, is used to supply BIOS like functionality and DRAM memory.

System 400 typically includes one or more of a WWAN transceiver 405 and a WLAN transceiver 406 for connecting to various networks, such as telecommunications networks and wireless Internet devices, e.g., access points. Additionally, devices 402 are commonly included, e.g., a transmit and receive antenna, oscillators, PLLs, etc. System 400 includes input/output devices 407 for data input and display/rendering (e.g., a computing location located away from the single beam system that is easily accessible by a user). System 400 also typically includes various memory devices, for example flash memory 408 and SDRAM 409.

It can be appreciated from the foregoing that electronic components of one or more systems or devices may include, but are not limited to, at least one processing unit, a memory, and a communication bus or communication means that couples various components including the memory to the processing unit(s). A system or device may include or have access to a variety of device readable media. System memory may include device readable storage media in the form of volatile and/or nonvolatile memory such as read only memory (ROM) and/or random access memory (RAM). By way of example, and not limitation, system memory may also include an operating system, application programs, other program modules, and program data.

Embodiments may be implemented as an instrument, system, method or program product. Accordingly, an embodiment may take the form of an entirely hardware embodiment, or an embodiment including software (including firmware, resident software, micro-code, etc.) that may all generally be referred to herein as a “circuit,” “module” or “system.” Furthermore, embodiments may take the form of a program product embodied in at least one device readable medium having device readable program code embodied thereon.

A combination of device readable storage medium(s) may be utilized. In the context of this document, a device readable storage medium (“storage medium”) may be any tangible, non-signal medium that can contain or store a program comprised of program code configured for use by or in connection with an instruction execution system, apparatus, or device. For the purpose of this disclosure, a storage medium or device is to be construed as non-transitory, i.e., not inclusive of signals or propagating media.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method for printing a three-dimensional structure, comprising:
identifying, using one or more sensors, a geographical three-dimensional location of a print head, wherein the print head is operatively coupled to a platform providing movement over a geographical terrain;
correlating the identified geographical location to a location identified within a print file, wherein the print file comprises dimensions and printed structure locations of a three-dimensional structure to be constructed; and
constructing the three-dimensional structure until the three-dimensional structure is constructed by iteratively:
moving, based upon the correlation, the print head to printed structure locations identified from the print file;
when the print head is located at a printed structure location, extruding a structure material from a structure material holding location operatively coupled to the platform; and
determining, based upon the print file, whether the three-dimensional structure is constructed.

2. The method of claim 1, wherein the moving the print head comprises moving the platform.

3. The method of claim 1, wherein the structure material comprises concrete.

4. The method of claim 1, wherein the extruding further comprises providing a supporting structure member from a structure member feeder coupled to the platform.

5. The method of claim 4, wherein the supporting structure member is provided through a plurality of layers of extruded structure material.

6. The method of claim 1, wherein the structure material comprises extruded plastic and wherein the print head comprises a heating mechanism for heating the plastic.

7. The method of claim 1, wherein the structure material comprises wood fiber infused clay.

8. The method of claim 1, wherein the constructing the three-dimensional structure comprises optimizing the movement of the print head and platform for printing.

9. The method of claim 1, wherein the extruding comprises determining a rate of feed for the extrusion based upon a consistency of the extrusion.

10. The method of claim 1, wherein the constructing the three-dimensional structure comprises providing feedback via a visual sensor located near the print head to a controller regarding the extrusion.

11. A system for printing a three-dimensional structure, comprising:
a platform providing movement over a geographical terrain;
a print head coupled to the platform;
a structure material holding location operatively coupled to the platform;
one or more sensors operatively coupled to the platform;
a processor operatively coupled to the one or more sensors;
a memory device operatively coupled to the processor, wherein the memory device stores instructions executable by the processor to:
identify, using the one or more sensors, a geographical three-dimensional location of the print head, wherein the print head is operatively coupled to the platform;
correlate the identified geographical location to a location identified within a print file, wherein the print file comprises dimensions and printed structure locations of a three-dimensional structure to be constructed; and
construct the three-dimensional structure until the three-dimensional structure is constructed by iteratively:
moving, based upon the correlation, the print head to printed structure locations identified from the print file;
when the print head is located at a printed structure location, extruding a structure material from the structure material holding location; and
determining, based upon the print file, whether the three-dimensional structure is constructed.

12. The system of claim 11, wherein the moving the print head comprises moving the platform.

13. The system of claim 11, wherein the structure material is selected from the group consisting of: concrete and wood fiber infused clay.

14. The system of claim 11, wherein the extruding further comprises providing a supporting structure member from a structure member feeder coupled to the platform.

15. The system of claim 14, wherein the supporting structure member is provided through a plurality of layers of extruded structure material.

16. The system of claim 11, wherein the structure material comprises extruded plastic and wherein the print head comprises a heating mechanism for heating the plastic.

17. The system of claim 11, wherein the constructing the three-dimensional structure comprises optimizing the movement of the print head and platform for printing.

18. The system of claim 11, wherein the extruding comprises determining a rate of feed for the extrusion based upon a consistency of the extrusion.

19. The system of claim 11, wherein the constructing the three-dimensional structure comprises providing feedback via a visual sensor located near the print head to a controller regarding the extrusion.

20. A product for printing a three-dimensional structure, comprising:
a storage device that stores code, the code being executable by a processor and comprising:
code that identifies, using one or more sensors, a geographical three-dimensional location of a print head, wherein the print head is operatively coupled to a platform providing movement over a geographical terrain;
code that correlates the identified geographical location to a location identified within a print file, wherein the print file comprises dimensions and printed structure locations of a three-dimensional structure to be constructed; and
code that constructs the three-dimensional structure until the three-dimensional structure is constructed by iteratively:
moving, based upon the correlation, the print head to printed structure locations identified from the print file;
when the print head is located at a printed structure location, extruding a structure material from a structure material holding location operatively coupled to the platform; and
determining, based upon the print file, whether the three-dimensional structure is constructed.
